(19) United States
(12) Patent Application Publication
(10) Pub. No.: US 2006/0105080 A1
(43) Pub. Date: May 18, 2006

(54) Composition comprising proteinaceous material, its preparation and use

(76) Inventors: Timothy Finnigan, North Yorkshire (GB); Robin Blanchard, North Yorkshire (GB)

Correspondence Address: NIXON & VANDERHYE, PC, 901 NORTH GLEBE ROAD, 11TH FLOOR, ARLINGTON, VA, 22203, US

(21) Appl. No.: 10/528,171

(22) PCT Filed: Sep. 17, 2003
(86) PCT No.: PCT/GB03/04123

§ 371 Date: Oct. 19, 2005

(30) Foreign Application Priority Data
Sep. 17, 2002 (GB) 0221516.8

(51) Int. Cl. A23C 9/12

(52) U.S. Cl. 426/61; 426/656

(57) ABSTRACT

A composition comprising particles of filamentous fungus and a proteinaceous material, especially gluten, is described. Inclusion of the filamentous fungus increases the time required for the gluten to develop texture which may make it easier to blend in order ingredients, desired in a foodstuff, into the gluten.

This invention relates to a composition comprising a proteinaceous material, its preparation and use and particularly although not exclusively relates to a foodstuff comprising a proteinaceous material.

It is known, for example from WO 00/15045 (DSM), WO96/21362 (Zeneca) and WO95/23843 (Zeneca) to use edible filamentous fungi as meat-substitutes, for example in the preparation of burgers and sausages. In such uses, filaments of the fungi are bound together, for example with egg albumin, and are texturised so that the product resembles muscle fibres and therefore has a meat-like appearance and texture. Meat substitutes of the type described have been widely commercially available for many years under the trade mark QUORN.

It is known to incorporate gluten into a range of goods to provide a fibrous, meat-like texture. US4238515 (Shemer) describes a novel physical form of gluten possessing net-like fibrous structure which is produced by agitating wheat gluten with a reducing agent such as sodium sulphite and sodium bisulphite, at a temperature below 70° C. EP0296963 (Shemer) discloses the use of ascorbic acid as an alternative to sodium sulphite or bisulphite in order to soften the sticky mass of gluten. WO99/137335 (Shemer) discloses the production of a food product comprising aligned bundles of formed fibres extending between faces of a food product, wherein the fibres are newly formed and fixed during preparation. Wheat gluten is disclosed as a recommended protein.

A significant problem associated with gluten is its physical form—it tends to form a sticky mass and consequentially it can be difficult to combine the gluten with other ingredients without modifying the gluten such as in the ways described above.

It is an object of the present invention to address problems associated with proteinaceous materials.

According to a first aspect of the present invention, there is provided a composition (preferably for use in the preparation of a foodstuff), said composition comprising fungal (preferably edible fungal) particles of a filamentous fungus and a proteinaceous material wherein the ratio of the weight on a dry matter basis of said proteinaceous material to the weight on a dry matter basis of said fungal particles in said composition is greater than 1.

Said fungal particles preferably comprise a filamentous fungus. Said filamentous fungus preferably comprises fungal mycelia and suitably at least 80 wt %, preferably at least 90 wt %, more preferably at least 95 wt % and, especially, at least 99 wt % of the fungal particles in said composition comprise fungal mycelia. Some filamentous fungi may include both fungal mycelia and fruiting bodies. Said fungal particles preferably comprise a filamentous fungus of a type which does not produce fruiting bodies. Where, however, a filamentous fungus of a type which produces fruiting bodies is used, the fungal particles in said composition suitably include at least 80 wt %, preferably at least 90 wt %, more preferably at least 95 wt % of fungal mycelia. Preferably, said fungal particles comprise substantially only fungal mycelia—that is, said fungal particles in said composition preferably do not include any fruiting bodies.

Preferred fungi for said fungal particles have a cell wall which includes chitin and/or chitosan. Preferred fungi have a cell wall which includes polymeric glucosamine. Preferred fungi have a cell wall which includes β1-3/1-6 glucans.

Said fungal particles may include fungal cells of the order Mucorales as described in Wo 00/15045 (DSM).

Said fungal particles preferably comprise fungus selected from fungi imperfecti.

Preferably, said fungal particles comprise, and preferably consist essentially of, cells of Fusarium species, especially of Fusarium venenatum A3/5(formerly classified as Fusarium graminearum) (IMI 145425; ATCC PTA-2684 deposited with the American Type Culture Collection, 10801 University Boulevard, Manassas, Va.) as described for example in WO96/21361 (Zeneca) and WO95/23843 (Zeneca).

Preferably, said fungal particles are non-viable. Preferably, said fungal particles have been treated to lower the level of RNA which they contain. Thus, the level of RNA in the fungal particles used is preferably less than the level in an identical fungus when in a viable state.

Fungal particles in said composition may comprise filaments having lengths of less than 1000 μm, preferably less than 800 μm. Said filaments may have a length greater than 100 μm, preferably greater than 200 μm. Preferably, fewer than 5 wt %, preferably substantially no, fungal particles in said composition have lengths of greater than 5000 μm; and preferably fewer than 5 wt %, preferably substantially no, fungal particles have lengths of greater than 2500 μm. Preferably, values for the number average of the lengths of said fungal particles in said composition are also as stated above.

Fungal particles in said composition may comprise filaments having diameters of less than 20 μm, preferably less than 10 μm, more preferably 5 μm or less. Said filaments may have diameters greater than 1 μm, preferably greater than 2 μm. Preferably, values for the number average of said diameters of said fungal particles in said composition are also as stated above.

Fungal particles in said composition may comprise filaments having an aspect ratio (length/diameter) of less than 1000, preferably less than 750, more preferably less than 500, especially of 250 or less. The aspect ratio may be greater than 10, preferably greater than 40, more preferably greater than 70. Preferably, values for the average aspect ratio of said fungal particles (i.e. the average of the lengths of the particles divided by the average of the diameters of the fungal particles) in said composition are also as stated above.

In the context of the present specification, a “major amount” when referred to a specified material, suitably means that at least 60 wt %, preferably at least 75 wt %, more preferably at least 90 wt %, especially at least 95 wt % of the specified material is present.

Said proteinaceous material may be a protein-containing material which when 25 wt % thereof is fully dispersed by mixing with 75 wt % of water at 25° C., and then left for 1 hour at the same temperature, the viscosity of the mixture increases, for example by at least 25%, so that the proteinaceous material develops a texture.

Said proteinaceous material may be a material of natural origin. It may be extracted from a material of natural origin.

Said proteinaceous is preferably substantially insoluble in water. Said proteinaceous material is preferably hydrophilic.

Said proteinaceous material preferably comprises a major amount of protein.

Said proteinaceous material preferably comprises a protein not of animal origin. Said proteinaceous material preferably includes no material of animal origin. It preferably comprises a vegetable protein.

Said proteinaceous material may comprise a cereal protein. Preferably, it includes a major amount of a cereal protein. Preferably, it consists essentially of a cereal protein. A preferred cereal protein is a wheat protein. Said proteinaceous material preferably comprises a major amount and more preferably consists essentially of a wheat protein.

Said proteinaceous material preferably comprises gluten and/or one or more consistuents of gluten preferably selected from gliadin and glutenin. More preferably, said proteinaceous material comprises gluten. It preferably includes a major amount of gluten and preferably consists essentially of gluten.

Preferably said gluten is a wheat gluten, more preferably vital wheat gluten.

Suitably, said ratio of the weight of said proteinaceous material to the weight of said fungal particles is greater than 2, preferably is greater than 4, more preferably is greater than 7 and, especially, is greater than 9. The ratio may be less than 50, preferably less than 30, more preferably less than 20, especially less than 15.

Said composition preferably includes water. The ratio of the weight of said proteinaceous material on a dry matter basis to the weight of water is suitably less than 1, preferably less than 0.75, more preferably less than 0.5, especially less than 0.35. Said ratio may be at least 0.05, suitably at least 0.1, preferably at least 0.15, more preferably at least 0.2, especially at least 0.25. It should be appreciated that the reference to the weight of water in said composition refers to the total water content in the composition irrespective of its origin.

From the above, it will be appreciated that a preferred composition may comprise fungal particles of a filamentous fungus, water and a proteinaceous material which comprises gluten, wherein said ratio of said proteinaceous material to fungal particles is greater than 7 and less than 30; and said ratio of said gluten to the weight of water is less than 0.75 and greater than 0.1.

According to a second aspect of the invention, there is provided a method of making a composition according to the first aspect, the method comprising contacting fungal particles and a proteinaceous material suitably in the presence of a solvent, preferably water. The components of said composition are preferably mixed, suitably to prepare a substantially homogenous composition. Preferably, in the method, 0.5 to 5 wt %, (especially 1 to 3 wt %) of fungal particles on a dry matter basis are contacted with 10 to 40 wt % (especially 15 to 30 wt %) of said proteinaceous material on a dry matter basis and with 55 to 89.5 wt % (especially 67 to 84 wt %) of water. Thus, said composition of said first aspect may comprise fungal particles, proteinaceous material and water in the amounts stated.

The composition described in said first and second aspects may have many applications. Preferred uses involve the preparation of foodstuffs but the composition may have non-food uses. For example, it may be used in lubricants or cosmetics.

According to a third aspect of the present invention, there is provided a foodstuff which comprises a composition as described according to said first aspect or one prepared according to said second aspect.

Said foodstuff may include said composition together with further edible components. Such components may be added to provide texture, flavour or other nutrients. The ratio of the total weight of said further edible components (on an “as used” basis—i.e. including any water which is associated with the components at the point of addition) to the weight of said proteinaceous material (especially gluten) in said foodstuff may be at least 1, preferably at least 1.5, more preferably at least 2. The ratio may be less than 5, preferably less than 4, especially less than 3.

The ratio of the weight of said further edible components to the weight of said edible fungal particles on a dry matter basis is suitably at least 10, preferably at least 15, more preferably at least 20, especially at least 25. The ratio may be less than 60, preferably less than 50, more preferably less than 40. Said further edible components may comprise one or more proteins, which are preferably of non-animal origin. Suitably, one or more of said proteins is a cereal protein. One or more of said proteins may be an ovoprotein, for example egg albumin. Said further edible components may include a source of fat. Said further edible component may include a fibrous material such as rusk.

In one preferred embodiment, said foodstuff may be a meat substitute. Such a foodstuff may include:

10 to 20 parts by weight (hereinafter “pbw”) of gluten;

0.5 to 5 pbw of edible fungal particles on a dry matter basis;

5 to 15 pbw of onions

3 to 9 pbw of fat

1 to 5 pbw of ovoprotein, especially egg albumin.

The foodstuff may include 5 to 30 pbw of other ingredients including seasoning.

Said foodstuff may be incorporated into a casing, for example a sausage casing or otherwise manipulated into a desired form.

Preferably, the foodstuff prepared is steam-cooked. Advantageously, this may improve the consumer acceptability of the product.

According to a fourth aspect of the present invention, there is provided a method of making a foodstuff according to said third aspect, the method comprising contacting a composition according to said first aspect or one prepared as described according to said second aspect with further edible components. In preferred embodiments proteinaceous and fat components are added prior to the addition of at least some seasoning (e.g. salt containing ingredient). Preferably, seasoning is added after a major amount (preferably substantially all) of the total amount of the further edible components have been added.

According to a fifth aspect of the invention, there is provided the use of filamentous particles for reducing the rate of increase of the viscosity of a composition of a cereal protein, for example gluten, in water.

In the first aspect described herein dimensions of fungal particles are described. The filamentous particles of the fifth aspect may have any of the dimensions described for said fungal particles according to the first aspect, even though the particles of the fifth aspect may not comprise fungal particles.

Additionally, the amounts/ratios described for said fungal particles of said first aspects may be applied to the particles of the fifth aspect, even though the particles of the fifth aspect may not comprise fungal particles.

Advantageously, the use described according to the fifth aspect may enable a range of other components to be contacted, for example, mixed with said cereal protein more easily and/or over a greater time period compared to a case wherein no filamentous particles are used.

Any feature of any aspect of any invention or embodiment described herein may be combined with any feature of any aspect of any other invention or embodiment described herein mutatis mutandis.

Specific embodiments of the invention will now be described with reference to the examples.

In the examples, the following materials are referred to:

Vital wheat gluten—a powdered ingredient obtained from Cerestar Ltd, U.K.

mycoprotein paste—refers to a visco-elastic material comprising a mass of edible filamentous fungus derived from Fusarium venenatum A3/5(formerly classified as Fusarium graminearum Schwabe) (IMI 145425; ATCC PTA-2684 deposited with the American type Culture Collection, 12301 Parklawn Drive, Rockville Md. 20852) and treated to reduce its RNA content to less than 2% by weight by heat treatment. Further details on the material are provided in WO96/21362 and WO95/23843. The material may be obtained from Marlow Foods Limited of Stokesley, U.K. It comprises about 25 wt % solids made up of non-viable RNA reduced fungal hyphae of approximately 400-750 μm length, 3-5 μm in diameter and a branching frequency of 2-8 tips per hyphal length.

Hobart mixer—a beater mixer with a planetary mixing action made by Hobart Corporation of Troy Ohio, U.S.A.

Stable Microsystems Texture Analyser—an apparatus for measuring texture supplied by Stable Microsystems of Surrey, England.

Kieffer Dough and Gluten Extensibility Rig—attachments for use with the aforementioned texture analyser.

Flaked Fat—partially hydrogenated vegetable fat obtained from Kelanco UK of Merseyside, UK.

Albumen—hen egg albumin obtained from G. Fiske & Co Ltd of Middlesex, England.

Rusk—a sage and onion mix obtained from RHM Ingredients of Ossett, England.

Examples 1 and 2 hereinafter describe investigations of the properties of mixtures comprising edible filamentous fungus and gluten.

### EXAMPLE 1a (COMPARATIVE) AND EXAMPLES 1b TO EXAMPLE 1h

Gluten doughs were prepared by mixing vital wheat gluten and different levels of mycoprotein together with salt and water. The preparation involved mixing the gluten with the other ingredients using a Hobart mixer at a fixed setting for 2 minutes. When mycoprotein paste was added to the mixture, the ratio of gluten to paste was adjusted such that a 1 wt % increase in the level of mycoprotein paste gave a 0.25 wt % decrease in the level of gluten with an associated balance of water. Table 1 details the levels of components used in Example 1a to 1 h. “Salt” refers to sodium chloride. The reference to the wt % of fungus is calculated on the basis that the mycoprotein paste comprises approximately 25 wt % of fungal hyphae on a dry matter basis.

TABLE 1

| | | wt % of | | | | |
|---|---|---|---|---|---|---|
| | wt % | fungus on | | | | |
| Example | mycoprotein | dry matter | % wt | % wt | % wt | % wt |
| No: | paste | basis | gluten | water | salt | Total |
| 1a | 0 | 0 | 23.9 | 74.4 | 1.7 | 100 |
| 1b | 0.5 | 0.125 | 23.78 | 74.02 | 1.7 | 100 |
| 1c | 1 | 0.25 | 23.65 | 73.65 | 1.7 | 100 |
| 1d | 2 | 0.5 | 23.4 | 72.9 | 1.7 | 100 |
| 1e | 4 | 1 | 22.9 | 71.4 | 1.7 | 100 |
| 1f | 5 | 1.25 | 22.7 | 70.6 | 1.7 | 100 |
| 1g | 6 | 1.5 | 22.4 | 67.2 | 1.7 | 100 |
| 1h | 8 | 2 | 21.9 | 68.4 | 1.7 | 100 |

After mixing, the dough was allowed to develop at ambient temperature until it was judged to have developed sufficient body so as to be amenable to preparation of a test piece with a Kieffer Dough and Gluten Extensibility Rig. Results are provided in Table 2 from which it will surprisingly be noted that the addition of mycoprotein to gluten increases the amount of time required for the gluten to develop defined texture, with the suggestion of an asymptote after 6 wt % mycoprotein paste addition.

TABLE 2

| | wt % mycoprotein | Time (mins) to |
|---|---|---|
| Example No | paste | develop texture |
| 1a | 0 | 38 |
| 1b | 0.5 | 68 |
| 1c | 1 | 90 |
| 1d | 2 | 152 |
| 1e | 4 | 258 |
| 1f | 5 | 283 |
| 1g | 6 | 371 |
| 1h | 8 | 360 |

### EXAMPLES 2a to 2h

Test pieces were prepared using the compositions described in Table 1 for assessment within the Kieffer Dough and Gluten Extensibility Rig in conjunction with the Stable Microsystems Texture Analyser

The assessment of the doughs involves tensile testing to measure the doughs' resistance to extension, toughness and extensibility. Results are provided in Table 3. The mechanical properties referenced in Table 3 were assessed at the time referred to for the samples in Table 2 for the formulations described in Table 1. In each case, values stated are the average of 5 identical samples.

TABLE 3

| | Test | Average | Average | Average |
|---|---|---|---|---|
| Example | mixture | toughness | resistance to | extensibility |
| No | used | (g/s) | Extension (g) | (mm |
| 2a | 1a | 2807 | 132 | −30 |
| | | (after 131 mins) | | |
| 2b | 1b | 1891 | 110 | −29 |
| 2c | 1c | 1501 | 65 | −27 |
| 2d | 1d | 1431 | 63 | −31 |
| 2e | 1e | 1199 | 63 | −24 |
| 2f | 1f | 1383 | 66 | −34 |
| 2g | 1g | 1320 | 64 | −30 |
| 2h | 1h | 389 | 29 | −17 |

It should be appreciated from Table 3 that, even at low levels of mycoprotein paste, there is an appreciable reduction in, for example, the toughness and resistance to extension of the doughs. It appears that the added fungus is able to interfere with the mechanism by which gluten texture develops. This in fact is also apparent simply by observing and handling the gluten doughs described in Table 1 and comparing doughs with and without added fungus.

As a consequence of the observation of the effect of fungus on gluten, it has been found to be possible to blend into a mixture of fungus/gluten (representing a continuous phase), other ingredients including dry powders (as a dispersed phase). This would otherwise be extremely difficult if gluten texture developed very rapidly as it normally does.

Example 3 to 5 describe the preparation and evaluation of sausages comprising mixtures of fungus and gluten as described above.

### EXAMPLE 3

### Bench Scale Development of Sausage

A meat-free sausage was prepared using the ingredients referred to in Table 4.

TABLE 4

| Ingredient | Wt % |
|---|---|
| Water | 45.3 |
| Vital Wheat gluten | 14.39 |
| Onion (frozen) | 10.26 |
| Textured wheat protein | 9.06 |
| Flaked Fat | 6.04 |
| Seasoning | 4.83 |
| Mycoprotein Paste | 4.83 |
| Albumen | 3.38 |
| Rusk | 1.81 |

In the preparation, the mycoprotein paste was mixed with water using a Hobart mixer for 2 minutes and the vital wheat gluten was then added with further mixing for one minute at which point the other ingredients were added with additional mixing for two minutes. The resultant mix was then manually filled into a sausage filler and the contents extruded into cellulose skins, filled to approximately 12 mm diameter. The filled skins were sealed at each end and then steamed in a steam oven (ambient 97° C.) for 20 minutes or until the centre temperature reached 90° C. for 5 minutes. Some of the steamed and filled casings were then blast frozen to a core temperature of −18° C. Products were evaluated by grilling to a centre temperature of 72° C.

The sausages prepared as described were found to have relatively high protein level which may be advantageous in certain situations. Additionally, advantageously, the cost of the sausages may be relatively low since relatively more of a relatively cheap ingredient (gluten) may be used compared to a relatively expensive ingredient (mycoprotein).

### EXAMPLE 4

### Scale-Up of Sausage Manufacture

The ingredients referred to in Table 4 were used to prepare sausages on a greater scale.

In the manufacture, mycoprotein paste was mixed with water and onion for 3 minutes using a Wolfking 1000 litre paddle mixer. Gluten and other dry ingredients were then added and mixed for a further 3 minutes. Flaked fat and seasoning were then added with further mixing for 2 minutes. The mix was then filled into cellulose skins using a Handtmann Filler. The product was then steamed to a core temperature of 90° C. after which the product was cooled by water drenching. Skins were removed and the product frozen to a core temperature of −18° C.

### EXAMPLE 5

### Sensory Evaluation of Sausages

Sausages prepared as described in Example 4 were independently assessed by a panel of individuals and compared to commercially available meat-free sausages prepared as described in WO95/23843 (Zeneca) and sold under the trade mark QUORN and also meat-free sausages sold under the trade mark LINDA MCCARTNEY. In summary, overall the panel found (on blind tastings) that sausages prepared as described herein were preferred over both of the commercially available sausages.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A composition comprising fungal particles of a filamentous fungus and a proteinaceous material wherein the ratio of the weight on a dry matter basis of said proteinaceous material to the weight on a dry matter basis of said fungal particles in said composition is greater than 1.

2. A composition according to claim 1, wherein the fungal particles in said composition include at least 80 wt % of fungal mycelia.

3. A composition according to claim 1, wherein fungal particles in said composition comprise filaments having a length of greater than 100 μm and less than 1000 μm.

4. A composition according to claim 1, wherein fungal particles in said composition comprise filaments having an aspect ratio of greater than 100 μm and less than 1000 μm.

5. A composition according to claim 1, wherein said proteinaceous material is a protein-containing material which when 25 wt % thereof is fully dispersed by mixing with 75 wt % of water at 25° C., and then left for 1 hour at the same temperature, the viscosity of the mixture increases so that the proteinaceous material develops a texture.

6. A composition according to claim 1, wherein said proteinaceous material is a material of natural origin or is extracted from a material of natural origin.

7. A composition according to claim 1, wherein said proteinaceous material is substantially insoluble in water at 25° C.

8. A composition according to claim 1, wherein said proteinaceous material comprises a cereal protein.

9. A composition according to claim 8, wherein said cereal protein is a wheat protein.

10. A composition according to claim 1, wherein said proteinaceous material comprises gluten and/or one or more constituents of gluten.

11. A composition according to claim 1, wherein said proteinaceous material consists essentially of gluten.

12. A composition according to claim 1, wherein said ratio of the weight of said proteinaceous material to the weight of said fungal particles is greater than 2 and less than 50.

13. A composition according to claim 1, wherein the ratio of the weight of said proteinaceous material to the weight of said fungal particles is greater than 7 and less than 50.

14. A composition according to claim 1, wherein the ratio of the weight of said proteinaceous material on a dry matter basis to the weight of water in said composition is at least 0.05 and is less than 1.

15. A composition according to claim 1, which comprises fungal particles of a filamentous fungus, water and a proteinaceous material which comprises gluten, wherein the ratio of said proteinaceous material to fungal particles is greater than 7 and less than 30 and the ratio of gluten to the weight of water in said composition is less than 0.75 and greater than 0.1.

16. A method of making a composition according to claim 1, the method comprising contacting fungal particles and a proteinaceous material in the presence of water.

17. A method according to claim 16 wherein, in the method, 0.5 to 5 wt % of fungal particles on a dry matter basis are contacted with 10 to 40 wt % of said proteinaceous material on a dry matter basis and with 55 to 89.5 wt % of water.

18. A foodstuff which comprises a composition according to claim 1.

19. A foodstuff according to claim 18, which includes:
10 to 20 parts by weight of gluten;
0.05 to 5 parts by weight of edible fungal particles on a dry matter basis;
5 to 15 parts by weight of onions;
3 to 9 parts by weight of fat; and
1 to 5 parts by weight of an ovoprotein.

20. A foodstuff according to claim 19, which is steam cooked.

21. A method of making a foodstuff according to claim 18, the method comprising contacting a composition according to as defined above with further edible components.

22. The use of filamentous particles for reducing the rate of increase of the viscosity of a composition of a cereal protein in water.

23. (canceled)
